(19) United States
(12) Patent Application Publication
(10) Pub. No.: US 2026/0356339 A1
(43) Pub. Date: Nov. 12, 2026

(54) ELECTRO-HYDRAULIC ACTUATOR FOR A BRAKE

(71) Applicant: Brembo S.p.A., Curno, Bergamo (IT)

(72) Inventors: Marco CARRARA, Curno, Bergamo (IT); Luca MAZZEI, Curno, Bergamo (IT); Paolo SALA, Curno, Bergamo (IT)

(21) Appl. No.: 19/142,271

(22) PCT Filed: Dec. 21, 2023
(86) PCT No.: PCT/IB2023/063081

§ 371 Date: Jun. 23, 2025

(30) Foreign Application Priority Data
Dec. 23, 2022 (IT) 102022000026670

(51) Int. Cl. B60T 13/74

(52) U.S. Cl. CPC B60T 13/745

(57) ABSTRACT

The present invention relates to an electro-hydraulic actuator (100) for actuating a brake caliper, in particular of a disc brake of a vehicle with two or more wheels, comprising: —an electric motor (1) with a drive shaft (2); —a transformation mechanism (3) connected to the drive shaft (2) to transform a rotary motion of the drive shaft (2) into a linear translatory motion along an axial direction (X-X) of a float (4) of a hydraulic pump or brake master cylinder of said brake to pressurize a brake fluid; —a first housing (5) configured to accommodate the transformation mechanism (3) and support a second housing (6) of the electric motor (1), said transformation mechanism (3) including: —a reduction unit (7) with at least one output interface (8) and configured to demultiply the rotary motion of the drive shaft (2) and transmit it to at least one output interface (8), —a transformation unit (10) for converting the rotary motion of the at least one output interface (8) into a translatory motion of the float (4), the transformation unit (10) comprising a rotating member (11), which is connected to the at least one output interface (8), and a thrust member (12), which is linearly translatable, wherein the rotating member (11) is mechanically coupled to the thrust member (12) so as to transform a rotation of the rotating member (11) into a linear translation of the thrust member (12) which allows a displacement in the axial direction (X-X) of the float (4), —a bearing (9) connected to the rotating member (11) and the first housing (5) to allow the rotation of the rotating member (11) with respect to the first housing (5), the rotating member (11) is connected to the bearing (9) by mechanical interference coupling and comprises plastically deformed portions (33) in contact with the bearing (9), avoiding a shape coupling, so that the bearing (9) transfers torque to the rotating member (11) by mechanical interference coupling and so that the rotating member (11) is supported by the bearing (9), discharging a constraining reaction of the transformation unit (10) due to the action of the float (4) on the brake fluid directly onto the bearing (9).

### FIELD OF THE INVENTION

The present invention relates to an electro-hydraulic actuator for a brake, as well as to a braking system for a vehicle, preferably of the brake by wire type.

### BACKGROUND ART

Braking systems of the BBW (“Brake By Wire”) type for cars are known and widespread, in which a linear transducer connected to a brake pedal is configured to detect the travel of the brake pedal and transmit an electric signal, indicative of the request for braking torque by the user, to a control unit. Such a control unit processes the signal of the transducer and controls an electric motor of a hydraulic pump as a function of the required braking torque. The hydraulic pump operated by the electric motor pressurizes and conveys a hydraulic fluid to the hydraulic pressure units of the vehicle brakes.

Compared to traditional braking systems, in which the brake pedal acts directly on the hydraulic circuit, the advantage of the “Brake By Wire” systems is the ability to generate and control the hydraulic pressure of the braking system without the aid of the force applied by the brake pedal. Moreover, the at least partial replacement of hydraulic circuits by electric circuits allows a saving in hydraulic fluid, a reduction in weight, and a reduction in the environmental impact of the whole braking system.

Solutions of electro-hydraulic actuators for a hydraulic brake are known, comprising an electric motor with a drive shaft and a transformation mechanism connected to the drive shaft for transforming a rotary motion of the drive shaft into a translatory motion of a translatable portion configured to act on the hydraulic pump.

The transformation mechanism comprises a mechanically coupled rotating member and a thrust member adapted to linearly translate with a rotation of the rotating member. In solutions of the known type, the rotating member is connected to a bearing so as to rotate with respect to a: housing of the linear actuator, receiving the rotary motion of the drive shaft. The bearing is usually connected to a reduction gear, which allows demultiplying the rotary motion of the drive shaft and transmitting the demultiplied rotary motion of the drive shaft to the rotating member.

The transformation mechanism is subject to constraining reactions transmitted by the translating portion acting on the hydraulic pump, which are discharged onto the housing of the linear actuator.

In the known solutions, the rotating member is usually connected to the bearing by shape coupling, where the bearing and the rotating member comprise a polygonal coupling seat and a polygonal coupling pivot, respectively, or vice versa, adapted to be shape-coupled to each other. In such known solutions, axial abutment surfaces are also provided between the bearing and the rotating member so that the constraining reactions transmitted from the translating portion acting on the hydraulic pump are discharged onto the bearing.

Although these solutions are satisfactory with respect to the transmission of torque from the motor to the rotating member, however these solutions do not prevent relative axial movements of the rotating member with respect to the bearing, which can lead over time to wear of the surfaces of the polygonal coupling seat and the polygonal coupling pivot, thus reducing the performance and reliability of the electro-hydraulic actuator.

In addition, it was found that the provision of axial abutment surfaces between the rotating member and the bearing can lead to a misalignment between the rotating member and the bearing, thus causing radial loads which compromise the reliability of the electro-hydraulic actuator.

Therefore, a need felt in the industry is to manufacture electro-hydraulic actuators for brakes, provided with transformation mechanisms which are safe and reliable over time compared to the known solutions.

A need felt in the industry is to manufacture electro-hydraulic actuators for brakes which allow simplified assembly, reduced components, as well as reduced weight and size, with equal performance of the electro-hydraulic actuator for a brake.

Therefore, a need strongly felt in the industry is to provide solutions of electro-hydraulic actuators which, at least with equal performance, are more compact, lighter, and have a small number of components while allowing a simplified assembly compared to the known solutions.

### SOLUTION

The present invention aims to provide an electro-hydraulic actuator, preferably a linear actuator, for a braking system of a vehicle, e.g., of the Brake by Wire type.

This and other objects and advantages are achieved by an electro-hydraulic actuator according to claim 1, as well as by a braking system according to claim 10.

Some advantageous embodiments are the subject of the dependent claims.

By virtue of the suggested solutions, it is possible to simplify the processing of the components of the linear actuator and facilitate the assembly thereof.

By virtue of the suggested solutions, it is possible to allow a torque transfer and a force transfer between the bearing and the rotating member by means of surfaces parallel to the thrust direction, avoiding to cause misalignments between the bearing and the rotating member.

By virtue of the suggested solutions, it is possible to ensure a higher compactness of the electro-hydraulic actuator, reducing the number of components compared to the known solutions.

By virtue of the suggested solutions, it is possible to ensure a simplified assembly of the mechanism for transforming the rotary motion of the drive shaft into a translation of the translating portion acting on a brake fluid, while reducing the assembly for electro-hydraulic actuators with equal times performance.

### DRAWINGS

Further features and advantages of the electro-hydraulic actuator and the braking system will be apparent from the description below of preferred embodiments thereof, given by way of non-limiting indication, with reference to the accompanying drawings, in which:

FIG. 1 shows an axonometric view of an electro-hydraulic actuator for a braking system according to the present invention;

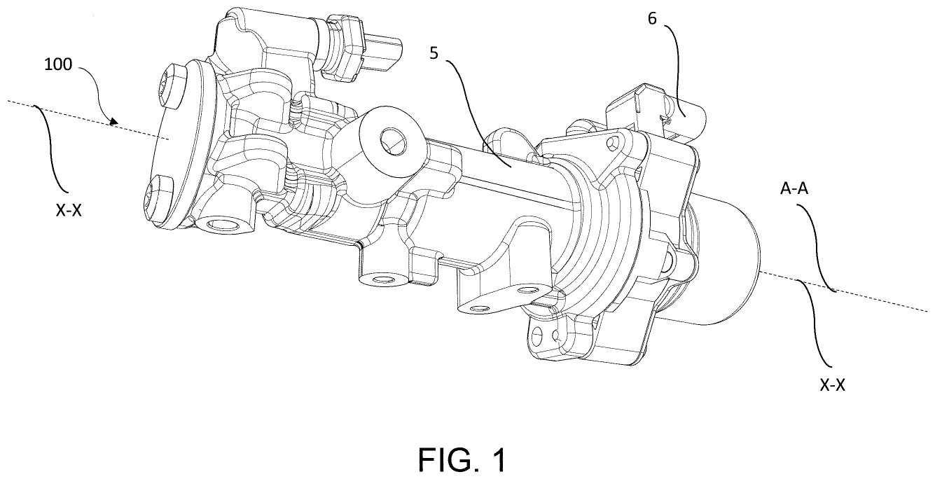

FIG. 2 shows an exploded axonometric view of the actuator in FIG. 1, sectioned along a cutting plane passing through the axial direction X-X along which a float adapted to act on a brake fluid is movable;

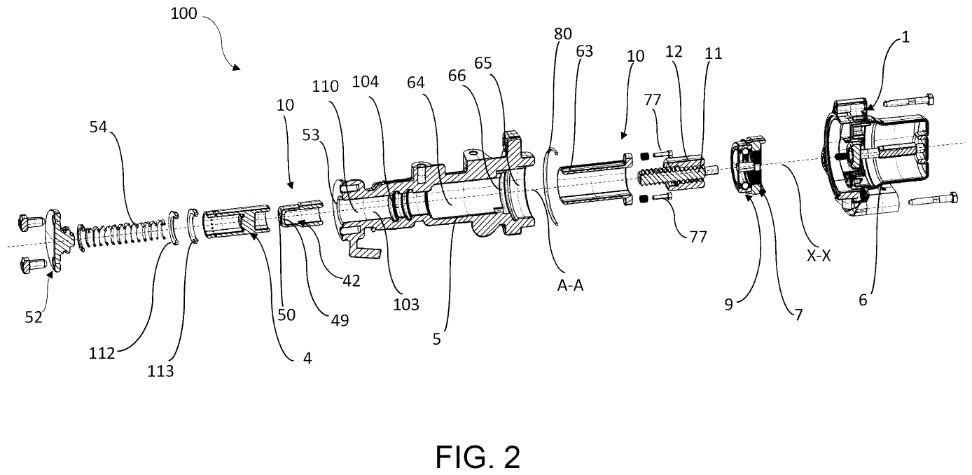

FIG. 3 shows a sectioned side view of the electro-hydraulic actuator, sectioned along a cutting plane passing through the axial direction X-X in FIG. 1;

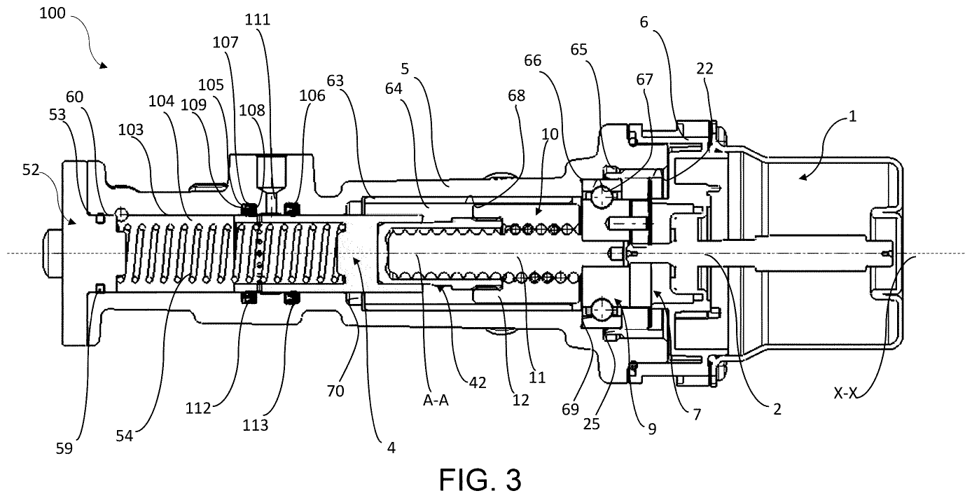

FIG. 4 shows a detail of the section in FIG. 3;

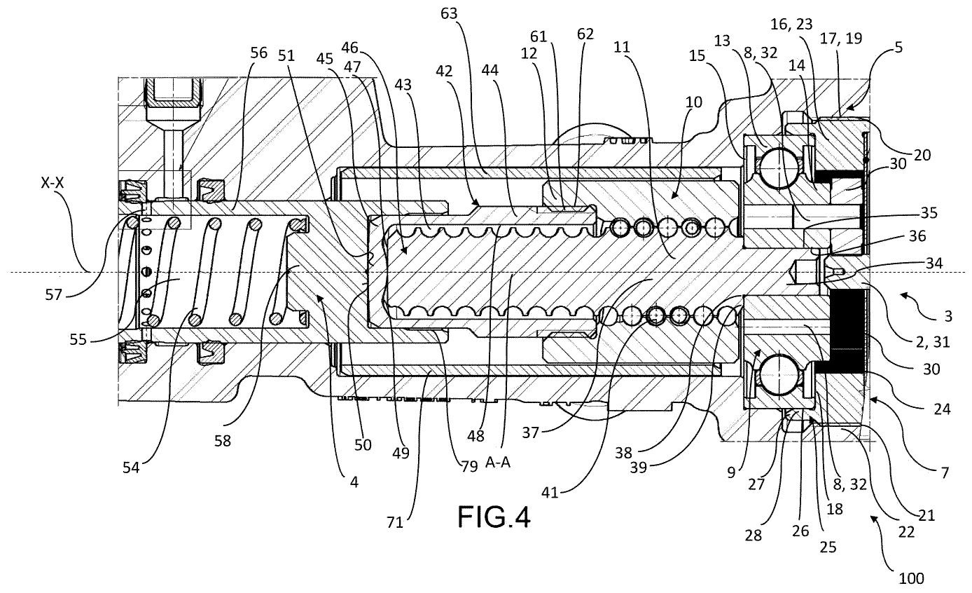

FIGS. 5 and 6 show axially opposite axonometric views of a gear of a reduction unit, adapted to be constrained to a first housing of the electro-hydraulic actuator by packing a bearing adapted to rotationally support a transformation unit so as to axially lock it and receive the constraining reactions transmitted from the transformation unit to the bearing;

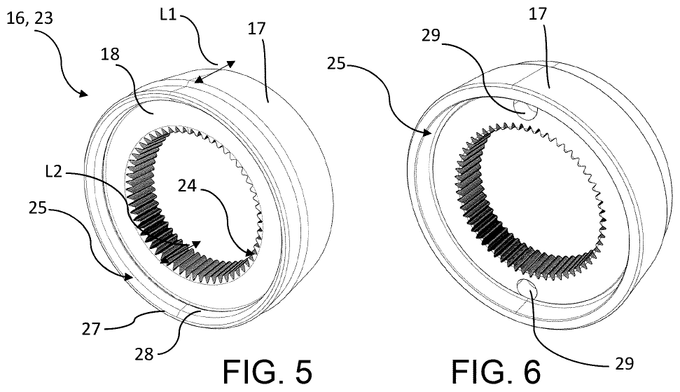

FIGS. 7 and 8 show axially opposite axonometric views of the transformation unit, such as a screw-nut assembly with recirculating balls, comprising a rotating member, e.g., a screw, mechanically couplable to a translating thrust member, e.g., a nut, for example by means of a plurality of balls, to allow a translation of the thrust member upon a rotation of the rotating member adapted to receive the rotation of the electric motor, a thrust cap adapted to be integral with the thrust member and come into contact with the float and pressurize, for example, a brake fluid in a pressure chamber connected to a braking device, and adapted to reduce friction between the rotating member and the thrust member, and an anti-rotation sleeve shaped so as to be inserted into the housing rotationally locked with respect to the first housing and so as to achieve a shape-coupling with the thrust member, for example by means of at least one flat surface, preferably two flat surfaces, directing a low-friction and rotation-proof translation of the thrust member, e.g., with at least one or more corresponding flat surfaces thereof;

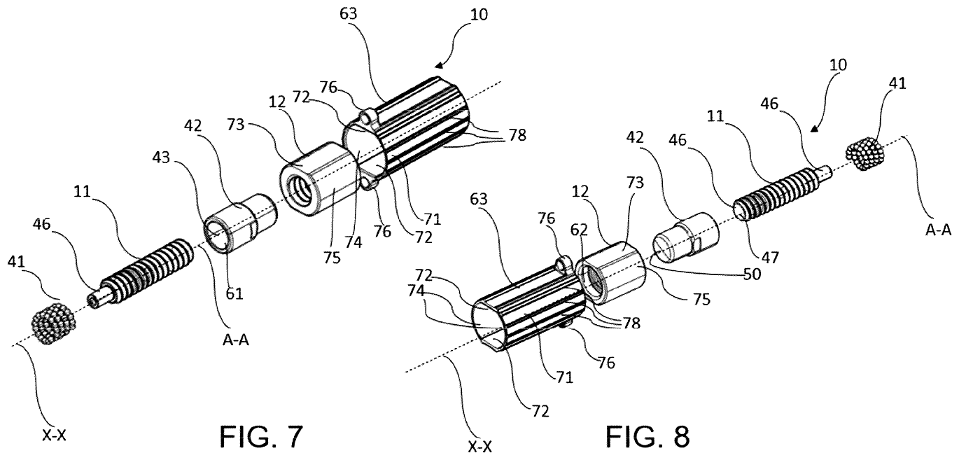

FIG. 9 is a detail of the section in FIG. 3, in which the bearing is shown, being held in the axial position thereof at least when subject to constraining reactions transmitted from the transformation unit to the bearing, from the constrained reduction unit to the first housing and configured to receive, from the bearing, the constraining reactions transmitted from the transformation unit.

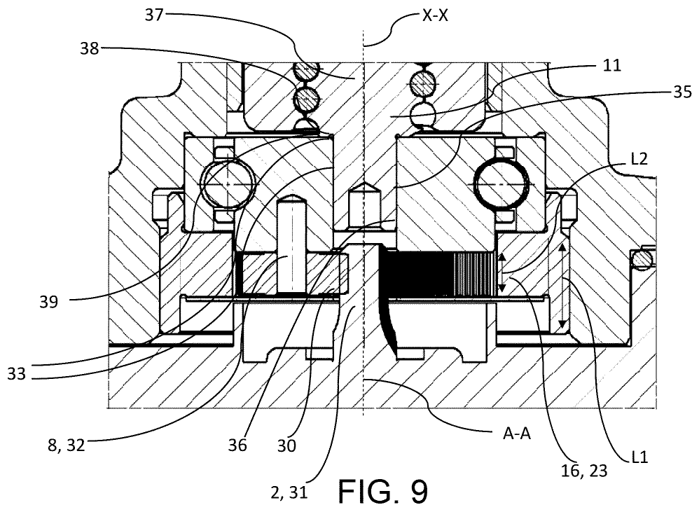

### DESCRIPTION OF SOME PREFERRED EMBODIMENTS

According to a general embodiment, an electro-hydraulic actuator for actuating a brake caliper, in particular of a disc brake of a vehicle with two or more wheels, is generally indicated by reference numeral 100.

The electro-hydraulic actuator 100 comprises an electric motor 1 with a drive shaft 2.

The electro-hydraulic actuator comprises a transformation mechanism 3 connected to the drive shaft 2 to transform a rotary motion of the drive shaft 2 into a linear translatory motion along an axial direction X-X of a float 4 of a hydraulic pump or brake master cylinder of said brake to pressurize a brake fluid.

The electro-hydraulic actuator comprises a first housing 5 configured to accommodate the transformation mechanism 3 and support a second housing 6 of the electric motor 1. In an embodiment, the electro-hydraulic actuator 100 comprises the second housing 6, where the second housing 6 is coupled to the first housing 5. According to an embodiment, the electro-hydraulic actuator 100 comprises a sealing gasket 80 interposed between the second housing 6 and at least one shoulder of the first housing 5.

The transformation mechanism 3 comprises a reduction unit 7 with at least one output interface 8 and configured to demultiply the rotary motion of the drive shaft 2 and transmit it to the at least one output interface 8.

The transformation mechanism 3 comprises a transformation unit 10 for converting the rotary motion of the at least one output interface 8 into a translatory motion of the float 4.

The transformation unit 10 comprises a rotating member 11, which is connected to the at least one output interface 8, and a thrust member 12, which is linearly translatable, where the rotating member 11 is mechanically coupled to the thrust member 12 so as to transform a rotation of the rotating member 11 into a linear translation of the thrust member 12 which allows a displacement in the axial direction X-X of the float 4.

The transformation mechanism 3 comprises a bearing 9 connected to the output interface 8, the rotating member 11 and the first housing 5, to allow the rotation of the rotating member 11 with respect to the first housing 5.

In an embodiment, the bearing 9 is packed between a first-housing shoulder 15 and said reduction unit 7 by constraining the bearing 9 in the first housing 5, so that a constraining reaction of the transformation unit 10 due to the action of the float 4 on the brake fluid is discharged directly onto the reduction unit 7.

By virtue of the provision of the reduction unit 7 constrainable to the first housing, it is possible to constrain the bearing inside the first housing without using additional mechanical stop components locking the bearing 9 in the seat thereof defined by the first housing, with a clearance equal to an assembly gap, or without clearance.

In an embodiment, the reduction unit 7 is constrained to the first housing 5, locking the bearing 9 with clearance in the seat thereof defined by the first housing leaving an assembly gap between the reduction unit and the bearing 9. For example, the assembly gap is defined by an axial distance between the bearing 9 when directly or indirectly abutting against a first-housing shoulder 15 and the reduction unit when constrained in a position of complete assembly with the first housing. For example, the assembly gap is less than a millimeter, preferably than half a millimeter. It is thus possible to avoid pre-load conditions, e.g., axial pre-load, for the bearing 9 and/or the reduction unit 7. The bearing 9, receiving the constraining reaction of the transformation unit 10 due to the action of the float 4 on the brake fluid, thus recovers the assembly gap and directly discharges onto the reduction unit 7 thus abutting against the reduction unit 7.

In an embodiment, the reduction unit 7 is constrained to the first housing 5 thus abutting against the bearing 9 and locks the bearing 9 in the seat thereof defined by the first housing without clearance.

In an embodiment, said reduction unit 7 comprises at least one rotationally locked reduction gear 16. In an embodiment, the reduction gear 16 comprises a reduction gear coupling portion 17 to form an integral connection with the first housing 5 of the transformation mechanism 3 configured to constrain, e.g., axially to prevent axial movements, the at least one reduction gear 16 inside the first housing 5.

By virtue of the provision of the reduction gear coupling portion 17 it is possible to constrain the reduction gear to the first housing 5, locking the rotation and the axial movements of the reduction gear 16, so that the bearing 9 is locked in the seat thereof, with or without clearance, discharging the constraining reactions due to the action of the float 4 directly onto the reduction gear 16.

According to an embodiment, the reduction gear coupling portion 17 comprises a thread. It is thus possible to screw the reduction gear 16 and/or the crown wheel 23 inside the first housing 5 until the abutment is achieved, or leave an assembly gap, with the reduction gear abutment portion against the bearing 9, thus ensuring the axial fixing of both the reduction gear 16 and/or the crown wheel 23 and the bearing.

In an embodiment, the reduction gear 16 comprises an abutment portion 18 adapted to abut against the bearing 9 forming an axial constraint for the bearing 9.

In an embodiment, the bearing 9 is tightened between the abutment portion 18 and the first-housing shoulder 15, either with or without clearance, so that the constraining reaction of the transformation unit 10 due to the action of the float 4 on the brake fluid is discharged directly onto the abutment portion 18 and indirectly on the first housing 5.

In an embodiment, the bearing 9 is a ball bearing.

In an embodiment, said reduction gear coupling portion 17 comprises at least one threaded portion 19 obtained on a radially outer reduction gear wall 21 of the reduction gear 16, which is adapted to be connected to a threaded counter-portion 20 obtained on a first radial wall 22 of said first housing 5, so as to constrain, for example axially to prevent movements along the axial direction X-X, the reduction gear 16 in the first housing 5, for example up to abut the reduction gear abutment portion 18 against the bearing 9 or reach a position of complete assembly, for example abutting against a first-housing shoulder, leaving an assembly gap between the reduction gear abutment portion 18 and the bearing 9.

In an embodiment, said reduction gear coupling portion 17 comprises a bayonet connection portion to be connected to a bayonet connection counter-portion obtained in a first radial wall 22 of said first housing 5, so as to constrain, for example axially to prevent movements along the axial direction X-X, the reduction gear 16 in the first housing 5 up to abut the reduction gear abutment portion 18 against the bearing 9.

In an embodiment, the reduction gear abutment portion 18 is an annular surface which axially delimits the reduction gear 16.

In an embodiment, said reduction unit 7 comprises a reduction gear 16, said reduction gear 16 comprising a crown wheel 23 with internal one-piece toothing and rotationally locked to the first housing 5.

In an embodiment, the electric motor 1 and the transformation mechanism 3 are arranged in cascade along said axial direction X-X.

In an embodiment, the bearing 9 comprises a fixed bearing portion 13 rotationally locked to the first housing 5 and a rotating bearing portion 14, which is rotatable with respect to the fixed bearing portion 13. In an embodiment, the fixed bearing portion 13 is a ring. In an embodiment, the rotating bearing portion 14 is a disc.

In an embodiment, the rotating bearing portion 14 is connected to the at least one output interface 8 so as to integrally rotate with the at least one output interface 8. In an embodiment, the rotating bearing portion 14 comprises the output interface 8.

In an embodiment, the rotating member 11 is connected to the rotating bearing portion 14 so as to rotate integrally with the rotating bearing portion 14.

In an embodiment, the bearing 9 is axially constrained inside the first housing 5 with the fixed bearing portion 13 abutting on one side against the first-housing shoulder 15 and on the other side against a reduction gear abutment portion 18 of the reduction unit 7.

In an embodiment, said crown wheel 23 with internal toothing comprises the reduction gear coupling portion 17 to form an integral connection with the first housing 5, axially locking the crown wheel 23 inside the first housing 5.

In an embodiment, said crown wheel 23 with internal toothing comprises a reduction gear abutment portion 18 adapted to abut and/or abuttingly receive the fixed bearing portion 13 thus axially locking the bearing 9 inside the first housing 5 so that the axial reaction of the transformation unit 10 due to the action of the float 4 on the brake fluid is discharged onto the reduction gear abutment portion 18 of said crown wheel 23.

In an embodiment, said crown wheel 23 with internal toothing comprises an interlocking portion 25 adapted to interfere with a radially outer bearing wall 26 of the fixed bearing portion 13 to radially tighten the fixed bearing portion 13. In an embodiment, said crown wheel 23 with internal toothing comprises an interlocking portion 25 adapted to accommodate, with clearance, a radially outer bearing wall 26 of the fixed bearing portion 13 to center a wheelbase of the pins of the bearing with the axis of the crown wheel 23.

In an embodiment, the reduction gear abutment portion 18 forms a shoulder for the interlocking portion 25, where the interlocking portion 25 axially projects in a cantilevered manner from the reduction gear abutment portion 18.

In an embodiment, said interlocking portion 25 comprises a flared portion 27 adapted to accommodate and forming a leading taper for a centered insertion of the fixed bearing portion 13 into the interlocking portion 25.

In an embodiment, said interlocking portion 25 comprises a contact portion 28 adapted to interfere and/or face the radially outer bearing wall 26 of the fixed bearing portion 13 to radially tighten the fixed bearing portion 13 and/or center the bearing 9 with the crown wheel 23.

In an embodiment, said crown wheel 23 comprises a central crown portion 24 having an internal toothing.

In an embodiment, the reduction gear coupling portion 17 extends axially over an axial coupling length L1, which is greater than an axial central portion length L2 along which the central crown wheel portion 24 axially extends. In an embodiment, the crown wheel 23 comprises at least one connection seat 29, such as a blind hole made on a surface axially opposite to the reduction gear abutment portion 18, adapted to receive a tool to connect, e.g., to screw, the crown wheel 23 to the first housing 5. In an embodiment, the reduction gear coupling portion 17 extends axially over an axial coupling length L1, which is smaller than an axial central portion length L2 along which the central crown wheel portion 24 axially extends.

In an embodiment, said reduction unit 7 comprises an epicyclic reduction gear or a harmonic reduction gear.

In an embodiment, said reduction unit 7 comprises at least a first reduction portion, which includes at least a first reduction stage, operatively associated with said crown wheel 23 with internal toothing.

In an embodiment, said reduction unit 7 comprises at least one planetary gear wheel train 30, and a central pinion 31 integral with and/or formed by the end of the drive shaft 2 and having an external toothing, where the planetary gear wheels 9 of the at least one planetary gear wheel train 9 mesh with both the central pinion 31 and the crown wheel 23.

In an embodiment, each planetary gear wheel 9 rotates about a planet gear pin or pivot 32. In an embodiment, each planet gear pin 32 is constrained to the rotating bearing portion 14. In an embodiment, the rotating bearing portion 14 comprises a satellite holder plate. In an embodiment, said at least one output interface 8 comprises each planet gear pin 32. In an embodiment, each planet gear pin 32 rotates on the same circumference about the axial direction X-X.

In an embodiment, the rotating member 11 comprises a shank portion 34. In an embodiment, the shank portion 34 has a side surface 35 laterally delimiting the shank portion. In an embodiment, said bearing 9 comprises a connection hole delimited by a connection hole surface 36. In an embodiment, the shank portion 34 is adapted to be connected to the connection hole.

In an embodiment, the rotating member 11 is connected to the bearing 9 by shape coupling. In an embodiment, the side surface 35 of the shank portion 34 and the connection hole surface 36 are polygonal surfaces adapted to be shape-coupled. For example, the side surface 35 of the shank portion 34 and the connection hole surface 36 are prismatic surfaces having a star-shaped base. According to an embodiment, the shank portion 34 is a star prism. In an embodiment, the connection hole delimits a star prism.

According to an aspect of the invention, the rotating member 11 is connected to the bearing 9 by mechanical interference coupling and comprises plastically deformed portions 33 in contact with the bearing 9, avoiding a shape coupling, so that the bearing 9 transfers a torque to the rotating member 11 by mechanical interference coupling and so that the rotating member 11 is supported by the bearing 9 discharging a constraining reaction of the transformation unit 10 due to the action of the float 4 on the brake fluid directly onto the bearing 9.

By virtue of the provision of the mechanical interference coupling, i.e., a force coupling, between the rotating member 11, such as. a screw of a screw-nut assembly, it is possible to simplify the processing of the connection system between the rotating member 11 and the bearing 9, avoiding making polygonal geometric shapes for shape-coupling a portion of the rotating member 11 to a portion of the bearing 9.

By virtue of the provision of the mechanical interference coupling, it is possible to transmit both the rotation torque and the axial force between the rotating member 11 and the bearing 9, through the same interference-coupled portions of the rotating member 11 and bearing 9.

In an embodiment, the shank portion 34 is cylindrical. In an embodiment, the shank portion 34 has an unsuitable shape to transfer a torque by shape coupling.

In an embodiment, said connection hole surface 36 is a cylindrical surface.

In an embodiment, the shank portion 34 comprises said plastically deformed portions 33 in contact with said connection hole surface 36.

In an embodiment, the cylindrical surfaces of the connecting hole 36 and the shank portion 34 are parallel to the thrust direction A-A.

In an embodiment, the rotating member 11 comprises a rotating body 37. In an embodiment, the shank portion 34 is connected to the rotating body 37 extending in a cantilevered manner from the rotating body 37 along the thrust direction A-A.

In an embodiment, the rotating body 37 comprises mechanical coupling means to be coupled to the thrust member 12.

In an embodiment, the rotating member 11 comprises an annular valley 38 on the rotating body 37 which surrounds the shank portion 34.

In an embodiment, the rotating member comprises an annular ridge 39 on the rotating body 37, where the annular ridge 39 abuts along the thrust direction A-A against a bearing abutment surface 40 opposite to the reduction unit 7.

In an embodiment, the transformation unit 10 is a screw-nut assembly, preferably with recirculating balls.

In an embodiment, the transformation unit 10 is a ball-in-ramp device.

In an embodiment, the rotating member 11 is a screw with a helical external thread. In an embodiment, the thrust member 12 is a nut comprising a helical internal thread. In an embodiment, the transformation unit 10 comprises a plurality of balls 41 arranged in contact between the helical internal thread and the helical external thread, where the thrust member 12 defines a recirculation channel for moving the balls 41.

In an embodiment, the transformation unit 10 has a central axis A parallel to or coincident with the axial direction X-X.

In an embodiment, the transformation unit 10 comprises a thrust cap 42 integrally connected to the thrust member 12 so that it translates linearly and integrally with the thrust member 12 between a resting configuration and a thrust configuration.

In an embodiment, the thrust cap 42 is configured to contact the float 4 and transfer a thrust action to the float 4.

In an embodiment, the thrust cap 42 extends in a cantilevered manner from the thrust member 12 and forms a cap cavity 43 adapted to accommodate the rotating member 11.

In an embodiment, the thrust cap 42 comprises a cap side wall 44 and a cap bottom wall 45. The cap side wall 44 comprises an inner cap side surface 48 radially delimiting the cap cavity 43 facing the rotating member 11 without mechanical couplings. The cap bottom wall 45 comprises an inner bottom cap surface 49 axially delimiting the cap cavity 43 facing a free end 46 of the rotating member 11.

The cap bottom wall 45 comprises an outer bottom cap surface 50 axially opposite to the inner bottom cap surface 49 and configured to contact the float 4 and transfer a thrust action to the float 4.

In an embodiment, the inner bottom cap surface 49 is tapered along said central axis A towards the free end 46 of the rotating member 11 so as to contact the free end 46 of the rotating member 11 only partially and about the central axis A.

In the resting configuration, the inner bottom cap surface 49 is in contact with the free end 46 defining a mechanical stop of the electro-hydraulic actuator 100.

In the thrust configuration, the outer bottom cap surface 50 and the float surface 4 are in contact transferring an axial force from the thrust member 12 to the float 4.

By virtue of the contact, at the central axis A between the tapered inner bottom cap surface 49 and the free end surface 46 facing the thrust cap 42, it is possible to ensure a mechanical stop for the electro-hydraulic actuator in the resting position thereof, with the thrust member 12 in the original or zero position from which it cannot be further retracted.

By virtue of the contact, at the central axis A between the tapered inner bottom cap surface 49 and the free end surface 46 facing the thrust cap 42, it is possible to limit the contact between the thrust cap 42 and the rotating member 11 to a surface portion about the central axis A, which is smaller than a section of the rotating member perpendicular to the axial direction X-X and/or to an exposed surface of the free end 46 of the rotating member 11 facing the axial direction X-X, and at most, it is possible to limit the contact between the thrust cap 42 and the rotating member 11 in a surface portion coincident with the point of contact through which the central axis A passes. In this manner, by reducing the contact surface between the thrust cap 42 and the rotating member 11, it is possible to facilitate the translation of the thrust cap 42 under the action of the rotating member 11 after reaching the mechanical stop between the two components, i.e., it is possible to reduce the static friction torque between the free end 46 of the rotating member 11 and the thrust cap 46 to be overcome, in order to allow a rotation of the rotating member 11 and the corresponding translation of the thrust cap 42, thus reducing or preventing seizures between the two contact surfaces.

In an embodiment, the outer bottom cap surface 50 is tapered along said central axis A towards the float 4 so as to contact the float 4 only partially and about the central axis A.

In an embodiment, the inner bottom cap surface 49 and the outer bottom cap surface 50 are tapered along said central axis A in opposite directions towards the free end 46 of the rotating member 11 and towards the float 4, respectively, so as to contact the free end 46 of the rotating member 11 and the float 4 only partially and about the central axis A, respectively.

By virtue of the provision of the outer bottom cap surface 50 tapered in the direction of the float 4 along the axial direction X-X with respect to the central axis A, it is possible to transfer the translation force of the thrust cap 42 generated by the coupling of the rotating member 11 of the thrust member 12, about the central axis A and at most on the central axis A.

In an embodiment, the inner bottom cap surface 49 is a curved surface centered on the central axis A. In an embodiment, the inner bottom cap surface 49 is a curved surface having a maximum centered on the central axis A. In an embodiment, the inner bottom cap surface 49 is a curved surface having the radius R1 centered on the central axis A.

In an embodiment, the outer bottom cap surface 50 is a curved surface centered on the central axis A. In an embodiment, the outer bottom cap surface 50 is a curved surface having a maximum centered on the central axis A. In an embodiment, the outer bottom cap surface 50 is a curved surface having the radius R2 centered on the central axis A.

In an embodiment, the radius R1 of the inner bottom surface 49 is smaller than the centered radius R2 of the outer bottom cap surface 50.

In an embodiment, the inner bottom cap surface 49 and the outer bottom cap surface 50 are curved surfaces, having opposite concavity.

In an embodiment, the inner bottom cap surface 49 is at least partially a cap surface of a sphere and/or a spheroid and/or an ellipsoid having a maximum centered on said central axis A and concavity facing said outer bottom cap surface 50, so that the maximum of the inner bottom cap surface 49 is configured to come into contact with the rotating member.

In an embodiment, the outer bottom cap surface 50 is at least partially a cap surface of a sphere and/or a spheroid and/or an ellipsoid having a maximum centered on said central axis A and concavity facing the inner bottom cap surface 49.

In an embodiment, the inner bottom cap surface 49 and the outer bottom cap surface 50 are at least partially cap surfaces of a sphere and/or a spheroid and/or an ellipsoid, axially opposite, with the vertex at said central axis A.

By providing a curved inner bottom cap surface 49, it is possible to increase the curvature and/or reduce the radius of such a surface, facilitating the translation of the thrust cap 42 under the action of the rotating member 11 after reaching the mechanical stop between the two components, i.e., it is possible to reduce the static friction torque between the free end 46 of the rotating member 11 and the thrust cap 46 to be overcome, in order to allow a rotation of the rotating member 11 and the corresponding translation of the thrust cap 42, thus reducing or preventing seizures between the two surfaces in contact.

In an embodiment, said free end 46 of the rotating member 11 comprises a central free end surface 47. In an embodiment, the central free end surface 47 is flat and perpendicular to the central axis A. In an embodiment, the central free end surface 47 is tapered along said central axis A towards the inner bottom cap surface 49 so as to contact the inner bottom cap surface 49 only partially and about the central axis A. In an embodiment, the central free end surface 47 is a curved surface centered on the central axis A. In an embodiment, the central free end surface 47 is a curved surface having a maximum centered on the central axis A. In an embodiment, the central free end surface 47 is a curved surface having the radius R3 centered on the central axis A. In an embodiment, the central free end surface 47 is at least partially a cap surface of a sphere and/or a spheroid and/or an ellipsoid having a maximum centered on said central axis A.

In an embodiment, in the resting configuration, the inner bottom cap surface 49 is in contact with the central free end surface 47.

In an embodiment, said float 4 delimits a float coupling seat 79 adapted to partially accommodate, with clearance, the thrust cap 42. The float 4 comprises a central float surface 51 axially delimiting the float coupling seat 79.

In an embodiment, the central float surface 51 is flat and perpendicular to the central axis A.

In an embodiment, the central float surface 51 is tapered along said central axis A towards the outer bottom cap surface 50 so as to contact the outer bottom cap surface 50 only partially and about the central axis A. In an embodiment, the central float surface 51 is a curved surface centered on the central axis A. In an embodiment, the central float surface 51 is a curved surface having a maximum centered on the central axis A. In an embodiment, the central float surface 51 is a curved surface having the radius R3 centered on the central axis A. In an embodiment, the central float surface 51 is at least partially a cap surface of a sphere and/or a spheroid and/or an ellipsoid having a maximum centered on said central axis A.

In the thrust configuration, the outer bottom cap surface 50 and the central float surface 51 are partially in contact transferring an axial force from the thrust member 12 to the float 4.

In an embodiment, the thrust cap 42 is made in one piece with said thrust member 12.

In an embodiment, the thrust cap 42 is made in one piece separate from said thrust member 12. In an embodiment, the thrust cap 42 and said thrust member 12 are made of different materials. In an embodiment, the thrust cap 42 is made of steel or aluminum, and said thrust member 12 is made of alloy steel.

In an embodiment, the thrust cap 42 comprises a cap coupling portion 61 adapted to be shape-coupled to a thrust member coupling counter-portion 62 of said thrust member 12, for example, by threading or by bayonet or interference coupling.

In an embodiment, the cap coupling portion 61 is a radially outer thread made on an end portion of the cap side wall 44 on the outer cap side surface.

In an embodiment, the thrust member coupling counter-portion 62 is made on a radially inner surface of the thrust member 12.

In an embodiment, each section of the thrust cap 42 has a smaller radial dimension than each section of the thrust member 12, avoiding direct or indirect interference of the cap side wall 44 with the first housing 5 or with an anti-rotation device 63 on which the thrust member 12 translates at low friction.

In an embodiment, each axial projection or orthogonal projection along said axial direction X-X of the thrust cap 42 is completely contained within each section of the thrust member 12, avoiding direct or indirect interference of the cap side wall 44 with the first housing 5 or with an anti-rotation device 63 on which the thrust member 12 translates at low friction.

By virtue of the provision of the thrust cap 42 it is possible to limit the axial extension of the thrust member 12, e.g., of the nut, and limit the weight of the transformation unit 10, and also limit the surfaces involved to the contact friction during the translation of the thrust member 42, only to the surfaces of the thrust member 42 in contact with the first housing 5 or with the surfaces of the anti-rotation device 63.

In an embodiment, the transformation unit 10 comprises an anti-rotation sleeve 63 housed in said first housing 5 and constrained to the first housing 5 and rotationally locked.

In an embodiment, the anti-rotation sleeve 63 delimits, with an anti-rotation side wall 71 thereof, an open cavity adapted to accommodate the transformation unit 10 so as to avoid direct contact between the thrust member 12 and the first housing 5.

In an embodiment, the anti-rotation side wall 71 comprises at least one flat straight anti-rotation surface 72 parallel to the axial direction X-X and adapted to face and slide, at low friction, on a respective flat straight thrust member surface 73 parallel to the axial direction X-X.

In an embodiment, the anti-rotation side wall 71 comprises at least two straight flat anti-rotation surfaces 72 parallel to the axial direction X-X adapted to face each other and slide, at low friction, on respective straight flat thrust member surfaces 73 parallel to the axial direction X-X.

In an embodiment, the anti-rotation side wall 71 comprises at least one curvilinear anti-rotation surface 74 parallel to the axial direction X-X, which connects the straight flat anti-rotation surface 72 on opposite sides.

In an embodiment, the anti-rotation side wall 71 comprises at least two curvilinear anti-rotation surfaces 74 parallel to the axial direction X-X, which connect the straight anti-rotation surfaces 72.

In an embodiment, the thrust member 12 comprises thrust member surfaces 75 adapted to face the curvilinear anti-rotation surfaces 74 without coming into contact therewith, so that the thrust member slides in contact with the straight anti-rotation surfaces 72.

In an embodiment, the two straight anti-rotation surfaces 72 face each other.

In an embodiment, the anti-rotation side wall 71, outside or on the radially outer side or on the side opposite to the delimited open cavity, comprises a plurality of axial ribbings 78. In an embodiment, the axial ribbings 78 are configured to center the anti-rotation sleeve 63 housed inside said first housing 5. In an embodiment, the axial ribbings 78 are configured to contact, with clearance or interference, the third radial wall 68 of first housing, delimiting a transformation unit seat 64, so as to connect, by rotationally locking, the anti-rotation sleeve 63 with the first housing 5.

In an embodiment, the anti-rotation sleeve 63 comprises at least one fixing flange 76 projecting in a cantilevered manner from the anti-rotation side wall 71, where the fixing flange 76 is adapted to be integrally constrained to the first housing 5. In an embodiment, the fixing flange 76 is adapted to be inserted into a respective seat obtained in the third radial wall 68 of first housing and in the second shoulder 69 of first housing.

In an embodiment, the anti-rotation sleeve 63 comprises two radially opposite fixing flanges 76 adapted to be inserted into appropriate seats obtained in the third radial wall 68 of first housing and in the second shoulder 69 of first housing. In an embodiment, the fixing flanges 76 are shape-coupled to the appropriate seats or mechanically coupled by means of fixing screws 77 to the appropriate seats.

In an embodiment, said anti-rotation sleeve 63 is made of a low-friction polymer material.

In an embodiment, said anti-rotation sleeve 63 is made of a metal material, e.g., steel or aluminum.

In an embodiment, said first housing 5 comprises a first radial wall 22 of first housing which delimits a reduction unit seat 65.

In an embodiment, said first housing 5 comprises a second radial wall 67 of first housing defining a bearing seat 66.

In an embodiment, said first housing 5 comprises a third radial wall 68 of first housing defining a transformation unit seat 64.

In an embodiment, said transformation unit seat 64 is in communication with the float seat 104 and with the reduction unit seat 65 and with the bearing seat 66.

In an embodiment, the first 1 radial wall 22 of first housing is connected to said second radial wall of first housing 67 by means of a first shoulder 15 of first housing.

In an embodiment, the second radial wall 67 of first housing is connected to said third radial wall 68 of first housing by means of a second shoulder 69 of first housing.

In an embodiment, the third radial wall 68 of first housing is connected to the cylinder wall 104 by means of a third shoulder 70 of first housing.

In an embodiment, the first housing 5 houses in cascade along the axial direction X-X: the reduction unit 7, the transformation unit 10, and the float 4.

In an embodiment, the first housing 5 delimits, at one end thereof, downstream of said float 4, an axial first-housing opening 53 on the side axially opposite to said electric motor 1.

In an embodiment, the electro-hydraulic actuator 100 comprises a hydraulic cap 52 fluid-tightly connected to said first housing 5 to close the axial first-housing opening 53. In an embodiment, said first housing 5 is made in one piece.

In an embodiment, the hydraulic cap 53 is made in a separate piece from said first housing 5.

In an embodiment, the sum of the axial extensions along the axial direction X-X of the reduction unit seat, the bearing seat and the transformation unit seat is greater than the axial extension of the float seat.

In an embodiment, the axial extension of the float seat is less than half the axial extension of the first housing 5.

By virtue of the provision of the hydraulic cap 52, it is possible to manufacture electro-hydraulic actuators 100 having a first housing 5 made in one piece having a great extension along the axial direction X-X, adapted to delimit a float seat, a transformation unit seat, a bearing seat and a reduction unit seat, simultaneously ensuring the possibility of internally processing, with high precision, the cylinder wall of the float seat without passing through the reduction unit seat, the bearing seat and the transformation unit seat with the work tools.

In an embodiment, the reduction unit 7, the transformation unit 10, and the float 4 are coaxial.

In an embodiment, the electro-hydraulic actuator 100 comprises an elastic element 54 housed inside said first housing 5 interposed between said hydraulic cap 52 and said float 4, constantly biasing said float 4 in the opposite direction to a float feeding direction.

In an embodiment, the electro-hydraulic actuator 100 comprises a hydraulic cap gasket 59 arranged between a hydraulic cap side wall 60 of the hydraulic cap 52 and the cylinder wall 103, so as to form a seal in the pressure chamber 110.

In an embodiment, said hydraulic cap 53 has a T-shaped section.

In an embodiment, the first housing 5 comprises a cylinder wall 103 internally delimiting a float seat 104.

In an embodiment, the cylinder wall 103 delimits a pressure chamber 110 fluidly connectable to a braking device. In an embodiment, the cylinder wall 103 delimits a primary gasket seat 105 and a secondary gasket seat 106.

In an embodiment, the first housing 5 defines a supply conduit 111 fluidly connectable to a tank and/or to a fluid feeding valve. Said supply conduit 111 leads into a supply opening 112 on said cylinder wall 103 between said primary gasket seat 105 and said secondary gasket seat 106.

In an embodiment, the primary gasket seat 105 is delimited radially by an axial seat wall 107 and axially by a first radial seat wall 108 and a second radial wall 109, connected as an undercut to said axial seat wall 107.

In an embodiment, the electro-hydraulic actuator 100 comprises the float 4. In an embodiment, the float 4 is slidingly housed in a sealing manner in the float seat 104 to pressurize a fluid in a pressure chamber 110 fluidly connectable to a braking device.

In an embodiment, the electro-hydraulic actuator 100 comprises a primary gasket 1.

In an embodiment, said primary gasket 1 is housed in said primary gasket seat 105 with axial clearance between said first radial seat wall 108 and said second radial wall 109. In an embodiment, when said primary gasket 1 abuts against said first radial seat wall 108, it is configured to form a seal with said float 102 and said primary seat axial wall 107, thus fluidly isolating the pressure chamber 110 and the supply conduit 111. In an embodiment, when said primary gasket 1 abuts against said second radial wall 109, it is configured to form a seal with said float 102, avoiding the formation of a seal with said primary seat axial wall 107, to fluidly connect the supply conduit 111 and the pressure chamber 110 to increase the fluid pressure in the pressure chamber. In an embodiment, said primary gasket is a three-lip gasket.

In an embodiment, the electro-hydraulic actuator 100 comprises a secondary gasket 113, where the secondary gasket 113 is housed in the secondary gasket seat 106 to form a static and dynamic seal with said float 102 and said cylinder wall 103. In an embodiment, for example, said secondary gasket 113 is a two-lip gasket.

According to an embodiment, the float 4 is axially movable between a float resting configuration and at least one advanced float configuration to pressurize a fluid, such as a brake fluid, in the pressure chamber 110.

In an embodiment, the float 4 comprises a first hollow float portion 55 delimited by a radial float wall 56. In an embodiment, the first hollow float portion 55 is in fluid connection with the pressure chamber 110. In an embodiment, the radial float wall 56 has at least one through radial opening 57.

In an embodiment, the float 4 delimits, with said radial float wall 56, a second hollow float portion, comprising said float coupling seat 79.

In an embodiment, the float 4 comprises an axial float wall 58, where the axial float wall 58 axially delimits, on the one side, the first hollow float portion 55 and, on the opposite side, the float coupling seat 79.

In an embodiment, the elastic element 54 is interposed between said hydraulic cap 52 and the axial float wall 58, constantly biasing said float 4 in the opposite direction to a float feeding direction.

In an embodiment, until said float 4 is arranged with said through radial opening 57 arranged between the primary gasket 112 and the secondary gasket 113, the pressure chamber 110 is in fluid communication with said supply conduit 111 by means of said through radial opening 57,

In an embodiment, when said float 4 is in said advanced float configuration, with said through radial opening 57 arranged to be axially advanced with respect to the primary gasket 112, the pressure chamber 110 is fluidly isolated from the supply conduit 111 by means of the primary gasket 112 in the fluid isolation configuration, and the float 4 pressurizes the fluid in the pressure chamber 110.

In an embodiment, when the fluid in the supply conduit 111 exceeds the pressure of the fluid in the pressure chamber 110, the primary gasket switches to the fluid communication configuration, allowing the pressure in the pressure chamber 110 to be increased.

In an embodiment, the primary gasket 112 is axially movable in the primary gasket seat 105 between a fluid isolation configuration, in which the primary gasket 112 forms a seal with the axial seat wall 107 and the first radial seat wall 108 and with the float 4, and a fluid communication configuration, in which the primary gasket 112 is spaced apart from the axial wall wall 112, and abuts against the second radial seat wall 112 allowing the fluid to pass and forming a seal with the float 4.

The present invention also relates to a braking system for vehicles, comprising at least one electro-hydraulic actuator 100 according to any one of the previously described embodiments, where said at least one hydraulic actuator 100 is in hydraulic connection with at least one braking device, such as a brake caliper.

LIST OF REFERENCE SIGNS

| | |
|---|---|
| 1 | electric motor |
| 2 | drive shaft |
| 3 | transformation |
| | mechanism |
| 4 | float |
| 5 | first housing |
| 6 | second housing |
| 7 | reduction unit |
| 8 | output shaft |
| 9 | bearing |
| 10 | transformation unit |
| 11 | rotating member |
| 12 | translatable thrust |
| | member |
| 13 | fixed bearing portion |
| 14 | rotating bearing |
| | portion |
| 15 | first shoulder |
| | of first housing |
| 16 | reduction gear |
| 17 | reduction gear |
| | coupling portion |
| 18 | reduction gear |
| | abutment portion |
| 19 | threaded portion |
| 20 | threaded |
| | counter-portion |
| 21 | radially outer |
| | reduction |
| | gear wall |
| 22 | first radial wall |
| | of first housing |
| 23 | crown wheel |
| 24 | central crown |
| | wheel portion |
| 25 | interlocking portion |
| 26 | radially outer bearing |
| | wall |
| 27 | flared portion |
| 28 | contact portion |
| 29 | connection seat |
| | for a tool |
| 30 | planetary gear wheels |
| 31 | central pinion |
| 32 | planet gear pin or pivot |
| 33 | plastically deformed |
| | portions |
| 34 | shank portion |
| 35 | shank side surface |
| 36 | connection hole surface |
| 37 | rotating body |
| 38 | annular valley |
| 39 | annular ridge |
| 40 | bearing abutment |
| | surface |
| 41 | balls |
| 42 | thrust cap |
| 43 | cap cavity |
| 44 | cap side wall |
| 45 | cap bottom wall |
| 46 | free end |
| 47 | central free end surface |
| 48 | inner cap side surface |
| 49 | inner bottom |
| | cap surface |
| 50 | outer bottom |
| | cap surface |
| 51 | central float surface |
| 52 | hydraulic cap |
| 53 | axial opening |
| | of first housing |
| 54 | elastic element |
| 55 | first hollow |
| | float portion |
| 56 | radial float wall |
| 57 | through radial opening |
| 58 | axial float wall |
| 59 | hydraulic cap gasket |
| 60 | hydraulic cap side wall |
| 61 | cap coupling portion |
| 62 | thrust member coupling |
| | counter-portion |
| 63 | anti-rotation sleeve |
| | or device |
| 64 | transformation |
| | unit seat |
| 65 | reduction unit seat |
| 66 | bearing seat |
| 67 | second radial wall |
| | of first housing |
| 68 | third radial wall |
| | of first housing |
| 69 | second shoulder |
| | of first housing |
| 70 | third shoulder |
| | of first housing |
| 71 | anti-rotation side wall |
| 72 | straight anti-rotation |
| | surfaces |
| 73 | straight thrust |
| | member surfaces |
| 74 | curvilinear anti-rotation |
| | surfaces |
| 75 | curvilinear thrust |
| | member surfaces |
| 76 | fixing flange |
| 77 | anti-rotation fixing |
| | screws |
| 78 | axial ribbings |
| 79 | float coupling seat |
| 100 | Electro-hydraulic |
| | actuator |
| 103 | cylinder wall |
| 104 | float seat |
| 105 | primary gasket seat |
| 106 | secondary gasket seat |
| 107 | axial seat wall |
| 108 | first radial seat wall |
| 109 | second radial wall |
| 110 | pressure chamber |
| 111 | supply conduit |
| 112 | primary gasket |
| 113 | secondary gasket |
| L1 | axial coupling length |
| L2 | axial central |
| | portion length |
| X-X | axial direction |
| R-R | radial direction |
| A | central axis |

1-10. (canceled)

11. An electro-hydraulic actuator (100) for actuating a brake caliper, in particular of a disc brake of a vehicle with two or more wheels, comprising:
an electric motor (1) with a drive shaft (2);
a transformation mechanism (3) connected to the drive shaft (2) to transform a rotary motion of the drive shaft (2) into a linear translatory motion along an axial direction (X-X) of a float (4) of a hydraulic pump or brake master cylinder of said brake to pressurize a brake fluid;
a first housing (5) configured to accommodate the transformation mechanism (3) and support a second housing (6) of the electric motor (1),
said transformation mechanism (3) including:
a reduction unit (7) with at least one output interface (8) and configured to demultiply the rotary motion of the drive shaft (2) and transmit it to at least one output interface (8),
a transformation unit (10) to convert the rotary motion of the at least one output interface (8) into a translatory motion of the float (4), the transformation unit (10) comprising a rotating member (11), which is connected to the at least one output interface (8), and a thrust member (12), which is linearly translatable along the axial direction (X-X), wherein the rotating member (11) is mechanically coupled to the thrust member (12) so to transform a rotation of the rotating member (11) into a linear translation of the thrust member (12) which allows a displacement in the axial direction (X-X) of the float (4),
a bearing (9) connected to the output interface (8), the rotating member (11) and the first housing (5) to allow the rotation of the rotating member (11) with respect to the first housing (5),
characterized in that
the rotating member (11) is connected to the bearing (9) by mechanical interference coupling and comprises plastically deformed portions (33) in contact with the bearing (9), avoiding a shape coupling, so that the bearing (9) transfers torque to the rotating member (11) by mechanical interference coupling and so that the rotating member (11) is supported by the bearing (9) discharging a constraining reaction of the transformation unit (10) due to the action of the float (4) on the brake fluid directly onto the bearing (9).

12. An electro-hydraulic actuator (100) according to claim 11, comprising at least one of the following features or a combination thereof:
wherein the rotating member (11) comprises a shank portion (34), wherein the shank portion (34) is cylindrical; wherein
said bearing (9) comprises a connecting hole delimited by a connecting hole surface (36), wherein said connecting hole surface (36) is a cylindrical surface, wherein the shank portion (34) comprises said plastically deformed portions (33) in contact with said connecting hole surface (35).

13. An electro-hydraulic actuator (100) according to claim 12, wherein the rotating member (11) comprises a rotating body (37), wherein the shank portion (34) is connected to the rotating body (37) extending in a cantilevered manner from the rotating body (37) along the thrust direction (A-A), wherein the rotating body (37) comprises mechanical coupling means for coupling to the thrust member (12),
wherein the rotating member (11) comprises an annular valley (38) on the rotating body (37) which surrounds the shank portion (34),
wherein the rotating member (11) comprises an annular ridge (39) on the rotating body (37), wherein the annular ridge (39) abuts along the thrust direction (A-A) against a bearing abutment surface (40) opposite to the reduction unit (7).

14. An electro-hydraulic actuator (100) according to claim 11, comprising at least one of the following features or a combination thereof:
wherein the transformation unit (10) is a screw-nut assembly, preferably with recirculating ball, or a ball-in-ramp device,
and/or wherein the rotating member (11) is a screw with an outer helical thread, and wherein the thrust member (12) is a nut comprising an inner helical thread, wherein the transformation unit (10) comprises a plurality of balls (41) arranged in contact between the inner helical thread and the outer helical thread.

15. An electro-hydraulic actuator (100) according to claim 11, wherein the transformation unit (10) has a central axis (A) either parallel to or coincident with the axial direction (X-X), the transformation unit (10) comprises a thrust cap (42) integrally connected to the thrust member (12) to translate linearly solidly with the thrust member (12) between a resting configuration and a thrust configuration,
wherein the thrust cap (42) is configured to contact the float (4) and transfer a thrust action to the float (4),
wherein the thrust cap (42) extends in a cantilevered manner from the thrust member (12) and forms a cap cavity (43) adapted to accommodate the rotating member (11),
wherein the thrust cap (42) comprises a cap side wall (44) and a cap bottom wall (45),
wherein the cap side wall (44) comprises an inner side cap surface (48) radially delimiting the cap cavity (43) facing the rotating member (11) without mechanical couplings,
wherein the cap bottom wall (45) comprises an inner cap bottom surface (49) axially delimiting the cap cavity (43) facing a free end (46) of the rotating member (11),
wherein the cap bottom wall (45) comprises an outer cap bottom surface (50) axially opposite to the inner cap bottom surface (49) and configured to contact the float (4) and transfer a thrust action to the float (4),
wherein each section of the thrust cap (42) has a smaller radial dimension than each section of the thrust member (12), avoiding any direct or indirect interference of the cap side wall (44) with the first housing (5) or an anti-rotation device (63) on which the thrust member (12) translates at low friction.

16. An electro-hydraulic actuator (100) according to claim 15,
wherein the inner cap bottom surface (49) is tapered along said central axis (A) towards the free end (46) of the rotating member (11) so as to contact only partially and about the central axis (A) the free end (46) of the rotating member (11), wherein in the resting configuration the inner cap bottom surface (49) is in contact with the free end (46) defining a mechanical stop of the electro-hydraulic actuator (100), and wherein in the thrust configuration the outer cap bottom surface (50) and the float (4) are in contact transferring an axial force from the thrust member (12) to the float (4).

17. An electro-hydraulic actuator (100) according to claim 16, comprising at least one of the following features or a combination thereof:
wherein the outer cap bottom surface (50) is tapered along said central axis (A) towards the float (4) so as to contact the float (4) only partially and about the central axis (A),
wherein in the thrust configuration the outer cap bottom surface (50) and the float (4) are in contact about the central axis (A) transferring an axial force from the thrust member (12) to the float (4),
and/or wherein
the inner cap bottom surface (49) and the outer cap bottom surface (50) are tapered along said central axis (A) in opposite directions toward the free end (46) of the rotating member (11) and toward the float (4), respectively, so as to contact only partially and about the central axis (A) the free end (46) of the rotating member (11) and the float (4), wherein in the resting configuration the inner cap bottom surface (49) is in contact with the free end (46) defining a mechanical stop of the electrohydraulic actuator (100), and wherein in the thrust configuration the outer cap bottom surface (50) and the float (4) are in contact about the central axis (A) transferring an axial force from the thrust member (12) to the float (4), and/or
wherein the thrust cap (42) comprises a cap coupling portion (61) adapted to be coupled to a thrust member coupling counter-portion (62) of said thrust member (12), for example by threading or bayonet connection.

18. An electro-hydraulic actuator (100) according to claim 17, comprising at least one of the following features or a combination thereof:
wherein the inner cap bottom surface (49) and the outer cap bottom surface (50) are at least partially axially opposite, curved surfaces having a respective maximum at said central axis (A),
and/or wherein said free end (46) of the rotating member (11) comprises a central free end surface (47) which is flat and perpendicular to the central axis (A), wherein in the resting configuration the inner cap bottom surface (49) is in contact with the central free end surface (47),
and/or wherein said float (4) delimits a float coupling seat (50) adapted to accommodate partially the thrust cap (42) with clearance, wherein the float (4) comprises a central float surface (51) axially delimiting the float coupling seat (50),
wherein the central float surface (51) is flat and perpendicular to the central axis (A), wherein in the thrust configuration, the outer cap bottom surface (50) and the central float surface (51) are partially in contact transferring an axial force from the thrust member (12) to the float (4).

19. An electro-hydraulic actuator (100) according to claim 18, comprising at least one of the following features or a combination thereof:
wherein the first housing (5) houses in cascade along the axial direction (X-X), where the axial direction (X-X) is straight: the reduction unit (7), the bearing (9), the transformation unit (10), and the float (4),
wherein the transformation unit (10) comprises an anti-rotation sleeve (63) housed in said first housing (5) and constrained to the first housing (5) and rotationally locked,
wherein the anti-rotation sleeve (63) delimits with an anti-rotation side wall (71) thereof an open cavity adapted to accommodate the transformation unit (10) so as to avoid direct contact between the thrust member (12) and the first housing (5),
wherein the anti-rotation side wall (71) comprises at least two rectilinear anti-rotation surfaces (72) parallel to the axial direction (X-X) adapted to face each other and slide at low friction on respective rectilinear thrust member surfaces (73) of the thrust member (12) parallel to the axial direction (X-X),
and/or wherein the bearing (9) is packed between a first housing shoulder (15) and said reduction unit (7) thus constraining the bearing (9) in the first housing (5), so that a constraining reaction of the transformation unit (10) due to the action of the float (4) on the brake fluid is discharged directly onto the reduction unit (7).

20. A braking system for vehicles, comprising at least one electro-hydraulic actuator (100) according to claim 11, wherein said at least one hydraulic actuator (100) is in hydraulic connection with at least one braking device, such as a brake caliper.
